(19) United States
(12) Patent Application Publication
(10) Pub. No.: US 2006/0198379 A1
(43) Pub. Date: Sep. 7, 2006

(54) Prefix optimizations for a network search engine

(75) Inventors: Srihari Cadambi, Cherry Hill, NJ (US); Srimat Chakradhar, Manalapan, NJ (US); Hirohiko Shibata, Yokohama (JP)

Correspondence Address: SUGHRUE MION, PLLC, 2100 PENNSYLVANIA AVENUE, N.W., SUITE 800, WASHINGTON, DC, 20037, US

(73) Assignees: NEC LABORATORIES AMERICA, INC., Princeton, NJ (US); NEC ELECTRONICS CORPORATION, Kanagawa (JP)

(21) Appl. No.: 11/133,227

(22) Filed: May 20, 2005

Related U.S. Application Data
(60) Provisional application No. 60/658,168, filed on Mar. 4, 2005.

(51) Int. Cl. H04L 12/56; H04L 12/54

(52) U.S. Cl. 370/395.32; 370/428

(57) ABSTRACT

A network router comprising at least one index table operable to store encoded values of a function associated with an input source address in at least two locations. The encoded values are obtained by hashing the input source address such that all the encoded values must be used to recover the function. At least one filtering table is provided that is operable to store prefixes of at least two different lengths, the prefixes corresponding to network addresses. The filtering table is indexed by entries in said index table. At least one result table is provided. The result table is operable to be indexed by entries in said index table. The result table stores destination addresses. At least one record in the filtering table has a prefix length field that is operable to store a prefix length of a prefix stored in said at least one record.

### RELATED APPLICATIONS

This Application claims priority from co-pending U.S. Provisional Application Ser. No. 60/658,168, with inventors Srihari Cadambi, Srimat Chakradhar, Hirohiko Shibata, filed Mar. 7, 2005, which is incorporated in its entirety by reference.

### FIELD

This disclosure teaches pre-processing techniques to perform prefix optimization for network search engines.

### BACKGROUND

### 1. References

The following papers provide useful background information, for which they are incorporated herein by reference in their entirety, and are selectively referred to in the remainder of this disclosure by their accompanying reference codes in square brackets (i.e., [3] for the paper by Dharmapurikar)
1. P Gupta, B Prabhakar, S Boyd. Near-Optimal Routing Lookups with Bounded Worst Case Performance. in Infocomm. 2000. Tel Aviv, Israel.
2. P Gupta, N McKeown, Algorithms for Packet Classification. IEEE Network, 2001. 15(2): p. 24-32.
3. S Dharmapurikar, P Krishnamurthy, D E Taylor, Longest prefix matching using bloom filters. in Proceedings of the 2003 conference on Applications, technologies, architectures, and protocols for computer communications. August 2003.
4. S Cadambi, J Kilian, P Ashar, H Shibata, BCAM: A High-Performance, Low-Power Network Router Using Bloomier Filters. 2004, NEC Laboratories America, Inc.
5. B Chazelle, J Kilian, R Rubinfeld, A Tal, The Bloomier Filter: An Efficient Data Structure for Static Support Lookup Tables. Proceedings, Symposium on Discrete Algorithms (SODA), 2004.
6. S Cadambi, S Chakradhar, Handling Access Control Lists with a Hash-based Search Engine, in NEC Laboratories Internal Technical Report. 2005.
7. S Cadambi, S Chakradhar, A Prefix Processing Technique for Faster IP Routing. 2005.
8. S Cadambi, S Chakradhar, described network service engine: The NEC Network Search Engine. 2004.
9. V Srinivasan, G Varghese, Fast Address Lookups Using Controlled Prefix Expansion. ACM Transactions on Computer Systems (TOCS), 1999. 17(1): p. 1-40.
10. V Srinivasan, G Varghese, Method and Apparatus for Fast Hierarchical Address Lookup using Controlled Expansion of Prefixes. 2000, U.S. Pat. No. 6,011,795, Washington University, St Louis: USA.

### 2. Introduction

An increased use of applications with high bandwidth requirements, such as video conferencing and real-time movies, has resulted in a steep growth in internet traffic as well as an increase in the number of hosts. In order to provide acceptable performance, communication links are being upgraded to support higher data rates. However, higher link speeds translate to better end-to-end performance only if network routers, which filtering and route Internet Protocol (IP) packets, are commensurately faster. A significant bottleneck in a network router is the IP address lookup, which is the process of forwarding a packet to its destination. This is commonly known as IP forwarding. Other important tasks performed by network routers such as packet classification are also made faster if this basic lookup process is accelerated.

Given a set of prefixes, the lookup problem consists of finding the longest prefix that matches an incoming header. A prefix corresponds to an internet address, or its initial portion. This problem is referred to as Longest Prefix Matching, or LPM. Three major categories of hardware solutions for LPM are content-addressable memories (CAMs), tree-based algorithmic solutions [1,2] and hash-based solutions [3,4].

Bloomier filter-based content addressable memory is discussed in [5] along with an architecture of a network service engine and a network router based on the concept of the Bloomier filter. The architecture was designed for LPM. Several instances of the architecture that may be put together to solve the more complex problem of packet classification is discussed in [6]. Thus, if the memory usage of the basic LPM architecture is reduced, it helps both LPM and packet classification in the implementations of the above discussed architecture.

A general, architecture-independent prefix-processing technique for LPM that benefits hash-based and tree-based approaches in described in [7]. Two architecture-specific prefix optimization techniques for LPM to reduce the memory usage and consequently the power and chip area of the implementation are discussed.

### 3. Background Information on Prefix Processing

A prefix of length L is a regular expression whose L most significant bits are valid, while all other bits are considered as “don't-cares”. We restrict ourselves to regular expressions that are integers (for instance, an internet address). The number of valid bits in a prefix is referred to as the prefix length. FIG. 1 shows an example set of prefixes distributed in four lengths. We refer to each length as a “bin” since it represents a container for a sub-set of prefixes.

a) An Example Network Search Engine

The architecture described in [8] is a hash-based lookup architecture based on embedded DRAM technology and is disclosed further in U.S. patent application Ser. No. 10/909,907 filed Aug. 2, 2004. It is characterized by low latency, low power, low cost and high performance. While it can be a general-purpose search engine, it can also be currently tailored to LPM and packet classification applications. When implemented for the LPM application, the described architecture has a guaranteed latency of 8 cycles per lookup, a 250 MHz clock implying 250 million lookups per second and 3-4 W worst-case power for 512K prefixes.

By way of background, the above architecture is described herein.

b) Technique for Setting Up the Network Service Engine

The described network service engine is based upon a content retrieval data structure called the Bloomier filter. It is an architecture that can store and retrieve information quickly. A function f:t→f(t) may be stored in the described architecture by storing various values of t and corresponding values of f(t). The idea is to quickly retrieve f(t) given t. In this network service engine, this retrieval is achieved in constant time. The following definitions assist in explaining how this may be achieved.

Storing a function f:t→f(t) in the described network service engine data structure in such a way that it can be retrieved in constant time is referred to as function encoding. Given a function f:t→f(t) stored in the described network service engine, the process of retrieving f(t) given t is referred to as performing a lookup.

Function encoding is done by storing the values of the function f(t) for several elements t. The collection of elements stored in the described network service engine data structure is the element set.

The core of the described network service engine consists of a Bloomier-filtering based data structure into which a function may be encoded. This data structure consists of a table indexed by K hash functions. This table is named as the Index Table. The K hash values of an element are collectively referred to as its hash neighborhood. The hash neighborhood of an element t is represented by HN(t).

If a hash function of an element produces a value that is not in the hash neighborhood of any other element in the element set, then that value is said to be a singleton.

The index table is set up such that for every t in the element set, any information corresponding to t (such as f(t)) may be safely written to a specific address belonging to the hash neighborhood of t. This address is called T(t). Information corresponding to t′ where t′!=t will not be stored in T(t). Rather t′ will have its own unique address, T(t′). It is desirable to find T(t) for all t in the element set. An example procedure for doing this is described hereunder.

Given t, the information stored in T(t) needs to be retrieved. This information could be f(t) for instance. For an element t the index of the hash function that corresponds to T(t) is called h_{T}(t) Although T(t) is in the hash neighborhood of t, during retrieval, h_{T}(t) is not known: h_{T}(t) is known only during function encoding and not during lookup.

In order to retrieve f(t) without knowledge of h_{T}(t), a solution is to store some information in every location in the hash neighborhood of t such that a simple Boolean operation of the values in all hash locations necessarily yields f(t). Specifically, once T(t) is found for a certain t in the element set (during function encoding), the following value is written into the location T(t):

Equation 1: Encoding values in the Index Table.

$$V ( t ) = ( {{⋀}^{i = K}}_{{i = 1}_{i != {h}_{τ} ( t )}} D [ {H}_{i} ( t ) ] ) ⋀ I ( t )$$

where “ˆ” represents the XOR operation, Hᵢ(t) the i'th hash value of t, D[Hᵢ(t)] the index table data at address Hᵢ(t), K the number of hash functions, I(t) any information corresponding to t that we want to store and retrieve and h_{T}(t) the index of the hash function that produces T(t). The result of the above computation, V(t), is stored in location T(t).

During a lookup, if the element is t, the information corresponding to t, I(t), may be retrieved by a XOR operation of the values in all hash locations of t:

Equation 2: Index Table Lookup.

$${{⋀}^{i = K}}_{i = 1} D [ {H}_{i} ( t ) ] = I ( t )$$

It remains then to find a way of discovering T(t) for all t, and perform the function encoding using the above XOR operation. The Bloomier-filtering uses a greedy algorithm to find T(t). The technique is described in detail in [5], and briefly described here.

First, an order Γ is defined on the elements to be stored in the described network service engine. Γ dictates that every element t has a corresponding hash value (in the hash neighborhood of the element) that is not hashed to by any of the elements appearing before t in the order. Once an order is found, the elements and encode values in their hash locations (Equation 1) are processed in the same order. This is in fact a sufficient condition for that hash location to be T(t). The reason is as follows. The first element in Γ, t₁, has a hash location that is not in the hash neighborhood of any other element. Therefore, information corresponding to t₁ can be safely stored in this hash location since no other element has been encoded yet. The second element in Γ, t₂, has a hash location that is not in the hash neighborhood of t₁. Since t₁ has already been encoded, information corresponding to t₂ can be safely written into this hash location. Note that during encoding, only one hash location per element is modified (written into). Hence, encoding t₂ will not corrupt any of the locations written to or read by t₁.

This applies to all elements in the order.

Such an order may be discovered using the following greedy technique. An element t₁ with a singleton is found and put at the bottom of a stack. The element t₁ is removed from the element set, and recursively repeat the process. The final stack obtained represents the elements in the required order Γ. The algorithm is shown in FIG. 2.

Like Bloom filters, the basic Bloomier filtering data structure also suffers from a small probability of false positives. This means that, when an element t′ is looked up, Equation 2 can produce an apparently legitimate value of I(t) even though t′ was never in the set of elements originally encoded into the Index Table. False positives are removed in the described network service engine by the addition of a second table called the Filtering Table, so called because it filters false positives. The Filtering Table has as many entries as the number of elements encoded in the Index Table. It contains the actual elements that are encoded in the Index Table, one element per location. During lookups, the idea is to compare the actual element stored in the Filtering Table with the element to be looked up, and thus eliminate false positives.

In the described architecture, this is done using the following method. During function encoding, the information corresponding to element t, I(t), is set to the address in the filtering table where t is stored. Assume a lookup for element t′ needs to be done. When I(t′) is retrieved from the Index Table, the stored element t″ can be retrieved from address I(t′) in the Filtering Table. Following this, t′ and t″ are compared. If the comparison fails, the lookup is a false positive. An advantageous method of doing this is to allocate sequential Filtering Table addresses to the elements in the order r determined during Index Table encoding.

4. An Architecture for the Described Network Service Engine

The described network service engine architecture consists of three tables: the Index Table, the Filtering Table and a third table called the Result Table. The function f(t) is encoded in the Index Table, and corresponding values of t are inserted in the Filtering Table as described above.

During a lookup for element t′, the Index Table retrieves an address I(t′) into the Filtering Table, from where the actual element t″ is retrieved for comparison with t′. In addition to the actual element, f(t′) may also be stored at address I(t′) in the Filtering Table. This portion of the Filtering Table is called as the Result Table since it holds the result. Note that the Result Table could also be implemented as a separate memory, distinct from the Filtering Table. However, the Filtering and Result Tables are “parallel” and have the same number of entries. The described network service engine architecture is shown in FIG. 3.

a) LPM Using the Above Architecture

A commonly used longest prefix matching (LPM) is described hereunder.

A prefix refers to an IP address or its initial portion. For instance, “100.10” is a prefix of “100.10.1.2”. A prefix database contains forwarding information for “100.10”. However, it may contain more refined forwarding information for the larger prefix “100.10.1.2”. Therefore, an incoming IP address must be compared with all prefixes, and the forwarding information corresponding to the longest matching prefix must be discovered.

For instance, consider a router which forwards “.com” packets to port A. If the router is located such that the domain “nec.com” is more easily accessible via port B, it should route “nec.com” packets to port B. Therefore, incoming packets with “nec.com” as their destination address will be forwarded to B, while all other “.com” packets to port A.

In the example shown in FIG. 1, packets with headers equal to “127.0.0.0” will be forwarded to port M (longest prefix match is in prefix length 32), while packets with headers equal to “127.0.0.1” will be forwarded to port H (longest prefix match is in prefix length 24).

The described network service engine architecture for LPM consists of the tables shown in FIG. 3 replicated for each unique prefix length. Each instance of FIG. 3 is referred to as a sub-cell. Although the figure shows the components of a sub-cell to be the Index, Filtering and Result Tables, the Result Tables could optionally be placed off-chip. Prefixes corresponding to the appropriate length are stored in each sub-cell. During operation, the incoming header is sent to all sub-cells in parallel, and the results from each sub-cell are sent to a priority encoder. Some sub-cells will produce a “positive output” (indicate a match), while others will not. From among the sub-cells that indicate a match, the output of the one corresponding to the longest prefix is the forwarding information for the input query. The described network service engine architecture for LPM is shown in FIG. 4.

A described network service engine-based architecture for packet classification, the multi-dimensional version of the LPM problem, is discussed in [6]. This uses the LPM architecture as building blocks. Hence the prefix optimization techniques described in this work will benefit both LPM and packet classification.

### SUMMARY

To overcome the disadvantages discussed above, the disclosed teachings provide a network router comprising at least one index table operable to store encoded values of a function associated with an input source address in at least two locations. The encoded values are obtained by hashing the input source address such that all the encoded values must be used to recover the function. At least one filtering table is provided that is operable to store prefixes of at least two different lengths, the prefixes corresponding to network addresses. The filtering table is indexed by entries in said index table. At least one result table is provided. The result table is operable to be indexed by entries in said index table. The result table stores destination addresses. At least one record in the filtering table has a prefix length field that is operable to store a prefix length of a prefix stored in said at least one record.

Another aspect of the disclosed teachings is a method of processing addresses in a network search engine, the method comprises receiving an input source address. The input source address are hashed to create encoded values of a function associated with the input source address such that all the encoded values are needed to recover the function. The encoded values are stored in an index table. A prefix of the input source address is stored in a filtering table, said filtering table operable to store prefixes of at least two different lengths. A length of the prefix is stored in the filtering table. The filtering table is indexed by entries in the index table. The destination addresses are stored in a result table. The results are indexed the result table by entries in said index table.

Another aspect of the disclosed teachings is a computer program product including computer-readable media that includes instructions to enable a computer to perform the disclosed techniques.

### BRIEF DESCRIPTION OF THE DRAWINGS

The above objectives and advantages of the disclosed teachings will become more apparent by describing in detail preferred embodiments thereof with reference to the attached drawings in which:

FIG. 1 shows an example prefix set.

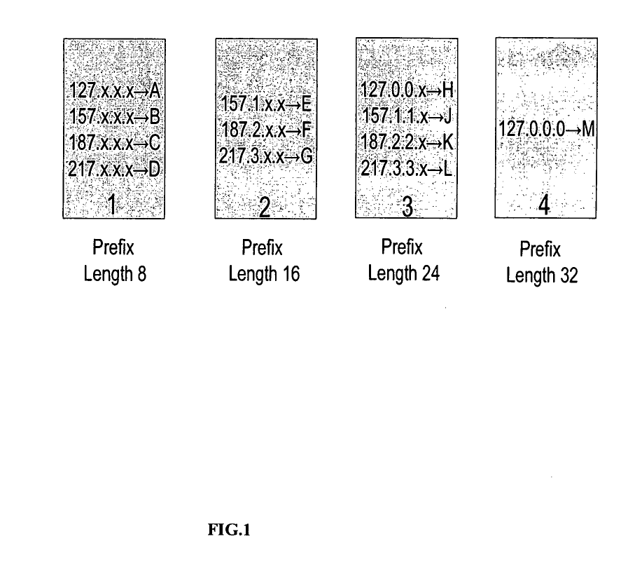

FIG. 2 shows an example index table encoding technique.

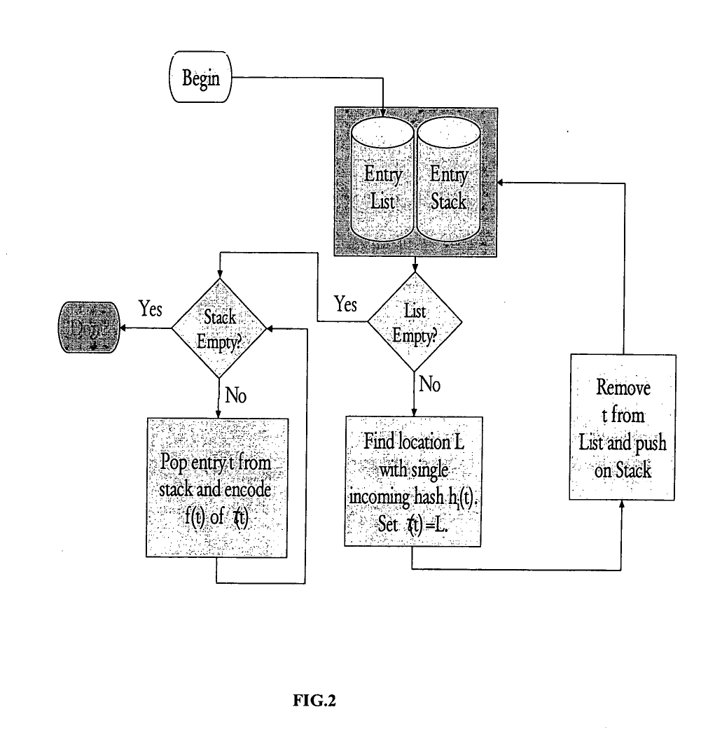

FIG. 3 shows an exemplary architecture for a network search engine.

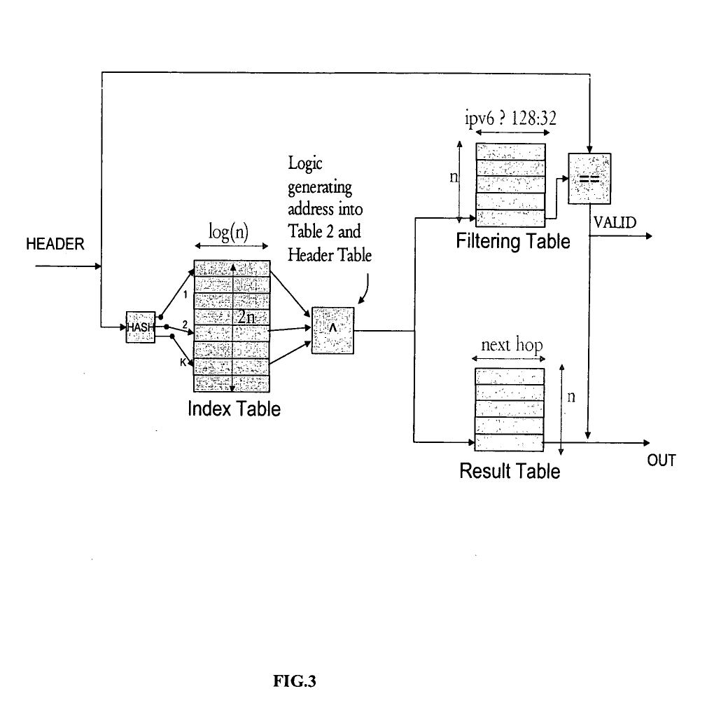

FIG. 4 shows an exemplary architecture for LPM.

FIG. 5 shows an example of creating bins with multiple prefix lengths.

FIG. 6 shows an example of using a modified cell in the network search engine for a bin containing multiple prefix lengths.

FIG. 7 shows an example of a modified LPM architecture.

FIG. 8 an example of reducing filtering table size.

### DETAILED DESCRIPTION

Multiple Prefix Length Per Sub-Cell in the Engine

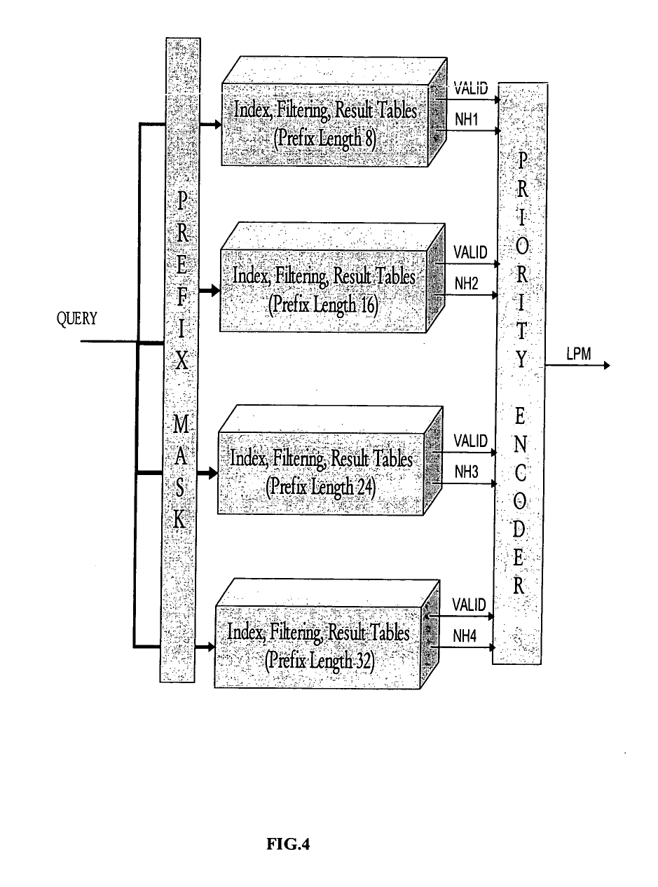

In the described network service engine LPM architecture shown in FIG. 4, each sub-cell contains prefixes of a single prefix length. This can be wasteful if certain prefix lengths contain relatively few prefixes (in practice, each set of tables is implemented with memory modules of medium to large granularity).

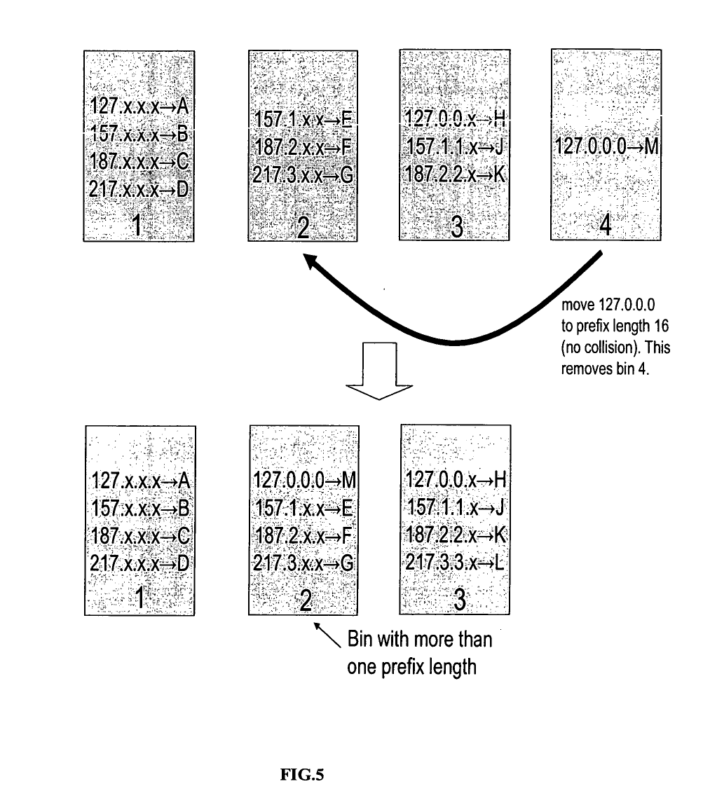

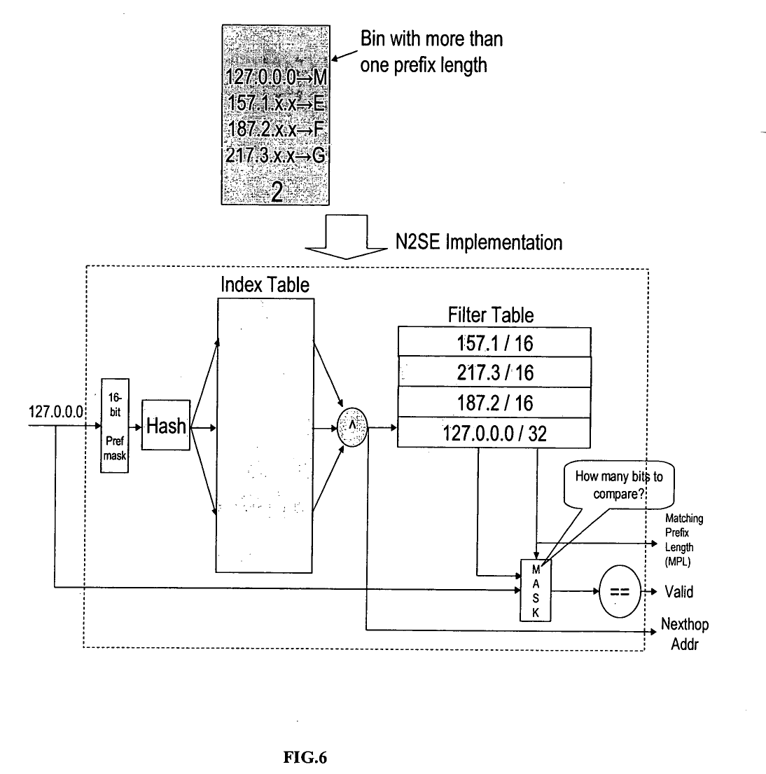

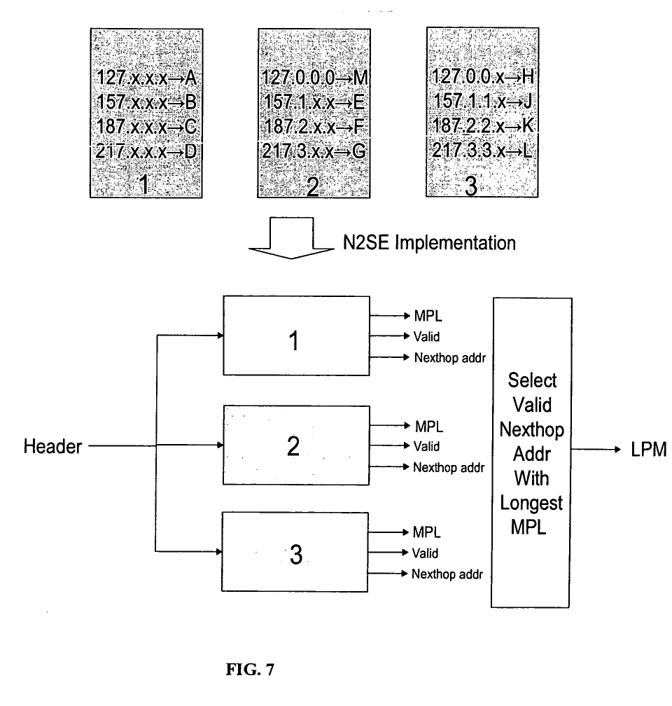

The above architecture is modified such that multiple prefix lengths can coexist in a single described network service engine sub-cell. This is shown in FIG. 5, FIG. 6 and FIG. 7.

FIG. 5 shows an example. The “bin” corresponding to prefix length 32 has relatively few (in this case, one) prefix lengths. The single prefix is moved to a bin that does not contain a sub-prefix of the prefix being moved. In the example in this figure, the bin containing prefixes of length 16 does not contain a sub-prefix of “127.0.0.0” which is being moved from prefix length 32.

FIG. 6 shows an example implementation of a modified described network service engine architecture for handling multiple prefix lengths within a single sub-cell. A prefix length field is added to the Filtering Table, and stored alongside every element. When an element t is stored in the Filtering Table (during function encoding), the prefix length corresponding to t is also stored at the same address I(t) (see Section I.C.3.b). As many bits of the element as specified in the prefix length must be stored in the Filtering Table. Upon a lookup, the prefix length field extracted from the Filtering Table indicates the number of bits that must be compared in order to indicate a legitimate match. In the example, 127.0.0.0, a prefix of length 32 is stored in a sub-cell that normally would contain only prefixes of length 16. It should be noted that a sub-prefix (namely, 127.0.x.x) does not exist in this prefix length (otherwise the move would have been illegal). In order to generate the hash functions, the 32-bit prefix is treated as a 16-bit prefix, i.e., only the 16 MSB bits of the 32-bit element are used for the hash functions. At the appropriate location in the Filtering Table, the prefix length (32) is stored, as well as the entire 32-bit prefix. A lookup is valid only if all 32-bits of a header match with the stored entry in the Filtering Table.

Each sub-cell now has three outputs: “matching prefix length (MPL)”, “valid” and “next hop” values. The MPL is used in the priority encoder to correctly determine the longest prefix match.

An advantage is that this technique moves prefixes from sparsely populated prefix lengths to other prefix lengths in order to utilize the described network service engine sub-cells more efficiently.

Reducing Filtering Table Size

In an described network service engine sub-cell, the size (depth) of the Filtering Table must be equal to or greater than the number of elements stored in the sub-cell (Section I.C.3.b). The technique present in this sub-section makes it possible for the Filtering Table to be smaller, i.e., the Filtering Table can have fewer entries than the number of elements stored in the described network service engine sub-cell.

An exemplary implementation of the technique is described below. If there exists a “complete set” S of 2^{P-}1 prefixes that have a common sub-prefix of length l, the largest subset of prefixes that have the same destination can be extracted and collapsed into a single Filtering Table location. For example, 0000*→E, 0001*→E, 0010*→E, 0011*→F comprise a complete set of 4 prefixes of length 4 with a common sub-prefix “00”. Without this technique 4 Filtering Table locations would be required for these prefixes. However, prefixes 0000*, 0001* and 0010* have the same destination E. The present technique collapses the into a single Filtering Table entry.

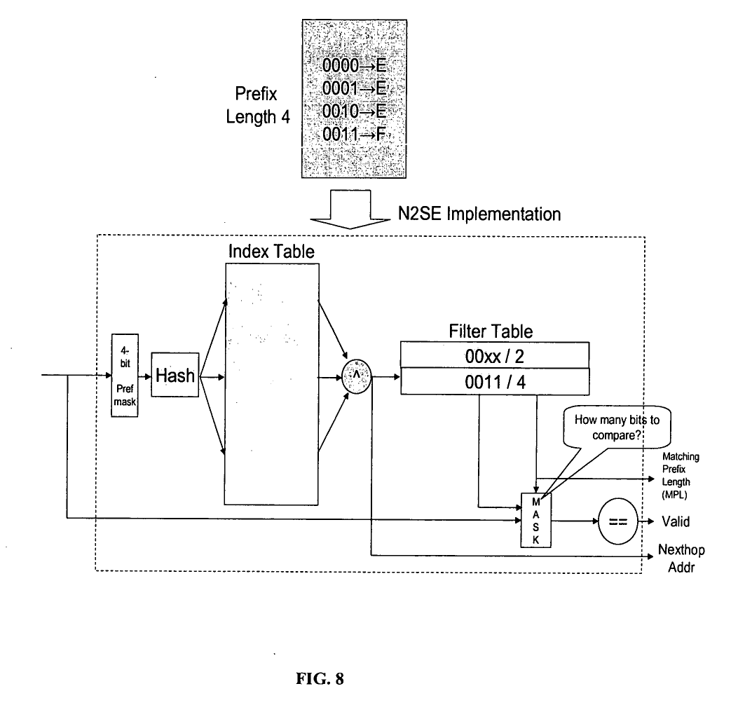

FIG. 8 shows an exemplary implementation of the above on the described network service engine. In order to support this change, the Filtering Table again has the extra field to indicate the prefix length. The three entries 0000, 0001 and 0010 will hash to different Index Table locations. However, the values encoded into these locations (I(t) from Section I.C.3.b) is the same for all three. This value points to a single Filtering Table location. The prefix length field in the Filtering Table location indicates how many bits to compare in order to filtering false positives. In this case, it is known that only 2 bits need to be compared for all three entries 0000, 0001 and 0010 while all 4 bits need to be compared for the last entry 0011 since that has a different destination and is therefore considered a separate entry.

In alternate embodiments, this technique can also be used in combination with prefix pre-processing that is described, for example, in [7, 9, 10].

The above discussed techniques can be implemented in any suitable computing environment. A computer program product including computer readable media that includes instructions to enable a computer or a computer system to implement the disclosed teachings is also an aspect of the invention.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A network router comprising:
at least one index table operable to store encoded values of a function associated with an input source address in at least two locations, said encoded values being obtained by hashing the input source address such that all the encoded values must be used to recover the function;
at least one filtering table, said filtering table operable to store prefixes of at least two different lengths, the prefixes corresponding to network addresses, said filtering table being indexed by entries in said at least one index table; and
at least one result table, said result table operable to be indexed by entries in said at least one index table, said result table storing destination addresses,
wherein at least one record in said filtering table having a prefix length field operable to store a prefix length of a prefix stored in said at least one record.

2. The network router of claim 1, wherein the prefix length indicates a number of bits in a network address that must be matched to obtain a legitimate match.

3. The network router of claim 1, wherein a subprefix of a higher length prefix in said at least two different lengths does not exist in a length corresponding to a lower length in said at least two different lengths and that a prefix of the higher length can be stored in the filtering table at a location corresponding to the lower length.

4. The network router of claim 1, wherein said network is operable to use a hash function that uses only bits of a lower length from a prefix having a higher length.

5. The network router of claim 1, wherein the network is operable to collapse a largest subset of prefixes having a same destination from a set of prefixes, said largest subset of prefixes having a common sub-prefix.

6. The network router of claim 5, wherein the collapsed subset of prefixes are stored in a single location in the filtering table.

7. A method of processing addresses in a network search engine, the method comprising:
receiving an input source address;
hashing the input source address to create encoded values of a function associated with the input source address such that all the encoded values are needed to recover the function;
storing the encoded values in an index table;
storing a prefix of the input source address in a filtering table, said filtering table operable to store prefixes of at least two different lengths;
storing a length of the prefix in a record in the filtering table;
indexing the filtering table being by entries in said index table;
storing destination addresses in a result table; and
indexing the result table by entries in said index table.

8. The method of claim 7, wherein a subprefix of a higher length prefix in said at least two different lengths does not exist in a length corresponding to a lower length in said at least two different lengths and the method further comprising:
storing a prefix of the higher length in the filtering table corresponding to a location corresponding the lower length.

9. The method of claim 7, wherein the hash function used for hashing uses only bits of a lower length from a prefix having a higher length.

10. The method of claim 7, further comprising:
collapsing a largest subset of prefixes having a same destination from a set of prefixes, said subset having a common sub-prefix.

11. The method of claim 10, further comprising:
storing the collapsed subset of prefixes in a single location in the filtering table.

12. A computer program product including computer readable media having instructions to enable a computer to process addresses in a network storage engine, the instructions including instructions for:
receiving an input source address;
hashing the input source address to create encoded values of a function associated with the input source address such that all the encoded values are needed to recover the function;
storing the encoded values in an index table;
storing a prefix of the input source address in a filtering table, said filtering table operable to store prefixes of at least two different lengths;
storing a length of the prefix in a record in the filtering table;
indexing the filtering table being indexed by entries in said index table;
storing destination addresses in a result table; and
indexing the result table by entries in said index table.

13. The computer program product of claim 12, wherein a subprefix of a higher length prefix in said at least two different lengths does not exist in a length corresponding to a lower length in said at least two different lengths and the instruction include further instructions for:
storing a prefix of the higher length in the filtering table at a location corresponding to the lower length.

14. The computer program product of claim 12, wherein the hash function used for hashing uses only bits of a lower length from a prefix having a higher length.

15. The computer program product of claim 12, wherein the instructions further include instructions for:
collapsing a largest subset of prefixes having a same destination from a set of prefixes, said subset having a common sub-prefix.

16. The computer program product of claim 15, wherein the instructions further include instructions for:
storing the collapsed subset of prefixes in a single location in the filtering table.
